(19) United States
(12) Patent Application Publication
(10) Pub. No.: US 2011/0222519 A1
(43) Pub. Date: Sep. 15, 2011

(54) Phase Rotating Method and Wireless Local Area Network Device

(76) Inventors: Yen-Chin Liao, Taipei City (TW); Cheng-Hsuan Wu, Taipei City (TW); Yung-Szu Tu, New Taipei City (TW)

(21) Appl. No.: 13/043,481

(22) Filed: Mar. 9, 2011

Related U.S. Application Data
(60) Provisional application No. 61/313,836, filed on Mar. 15, 2010.

(30) Foreign Application Priority Data
Dec. 24, 2010 (TW) 099145737

(51) Int. Cl. H04W 84/02

(52) U.S. Cl. 370/338

(57) ABSTRACT

The present invention discloses a phase rotating method for a wireless local area network (WLAN) device, which utilizes a channel including a plurality of sub-channels. The phase rotating method includes steps of generating a plurality of data sequences corresponding to the plurality of sub-channels, and making the plurality of data sequences with phase rotations according to a plurality of angles corresponding to the plurality of sub-channels. The channel is a non-contiguous channel.

### CROSS REFERENCE TO RELATED APPLICATIONS

This application claims the benefit of U.S. Provisional Application No. 61/313,836, filed on Mar. 15, 2010 and entitled “METHOD FOR SIGNAL ROTATION”, the contents of which are incorporated herein by reference.

### BACKGROUND OF THE INVENTION

1. Field of the Invention

The present invention relates to a phase rotating method for a wireless local area network (WLAN) and a WLAN device, and more particularly, a phase rotating method and WLAN device for transmission in a non-contiguous channel.

2. Description of the Prior Art

Wireless local area network (WLAN) technology is one of popular wireless communication technologies, which is developed for military use in the beginning and in recent years, is widely implemented in consumer electronics, e.g. desktop computers, laptop computers, personal digital assistants, etc., to provide the masses with a convenient and high-speed internet communication. IEEE 802.11 is a set of standards carrying out wireless local area network created by the Institute of Electrical and Electronics Engineers, including the former IEEE 802.11a/b/g standard and the current IEEE 802.11n standard.

IEEE 802.11a/g/n standards use orthogonal frequency division multiplexing (OFDM) method which have advantages of high spectrum utility efficiency and capability of resisting signal attenuation caused by a multipath propagation; whereas, as to transmitters in WLAN systems, the peak-to-average power ratio (PAPR) of modulated signals may easily be excessively high, and a distortion may occur when the modulated signals are processed in radio frequency (RF) circuits of the transmitters, resulting in a decrease of packet detection probability in a receiver. Different from IEEE 802.11a/g standard, IEEE 802.11n standard is further improved by adding a multiple-input multiple-output (MIMO) technique and other features that greatly enhances data rate and throughput. In addition, in IEEE 802.11n standard the channel bandwidth is doubled from 20 MHz to 40 MHz.

Please refer to FIG. 1, which is a diagram of an IEEE 802.11n packet structure according to the prior art. An IEEE 802.11n packet consists of a preamble portion in the front of a packet and a payload portion after the preamble portion, carrying data to be transmitted. An IEEE 802.11n preamble is a mixed format preamble and is backward compatible with IEEE 802.11a/g standard devices, and includes legacy Short Training field (L-STF), legacy Long Training field (L-LTF), legacy Signal field (L-SIG), high-throughput Signal field (HT-SIG), high-throughput Short Training field (HT-STF), and high-throughput Long Training fields (HT-LTF). L-STF is used for start-of-packet detection, automatic gain control (AGC), initial frequency offset estimation, and initial time synchronization. L-LTF is used for further fine frequency offset estimation and time synchronization. L-SIG carries the data rate (which modulation and coding scheme is used) and length (amount of data) information. HT-SIG also carries data rate and length information, and is used for packet detection so that the mixed format or the legacy format the transmitted packet uses can be detected. HT-STF is used for automatic gain control. HT-LTF is used for MIMO channel detection.

To achieve a higher throughput, the IEEE committee is creating an improved IEEE 802.11ac standard, included in IEEE 802.11 VHT (Very High Throughput) standard. Compared to the channel bandwidth of 40 MHz in IEEE 802.11n standard, the channel bandwidth in IEEE 802.11ac standard is greater than 40 MHz, e.g. 80 MHz. However, availability of contiguous 80 MHz channels is scarcer with the spectrum becoming progressively overcrowded. Thus non-contiguous transmission has been proposed to increase the probability of utilizing more bandwidth for data transmission. However, conventional phase rotation methods for contiguous 40 MHz channels cannot be directly applied in non-contiguous channels with more bandwidths to reduce peak-to-average power ratios. Hence, there is need for a signal rotation method to reduce PAPR for non-contiguous channel configurations.

### SUMMARY OF THE INVENTION

It is therefore a primary objective of the present invention to provide a phase rotating method for a wireless local area network (WLAN) device and a WLAN device.

The present invention discloses a phase rotating method for a WLAN device, WLAN device utilizing a channel comprising a plurality of sub-channels. The phase rotating method comprises generating a plurality of data sequences corresponding to the plurality of sub-channels; and performing phase rotations on the plurality of data sequences according to a plurality of angles corresponding to the plurality of sub-channels; wherein the channel is a non-contiguous channel.

The present invention further discloses a WLAN device, for executing the above-mentioned phase rotating method.

The present invention further discloses a phase rotating method for a WLAN device, the WLAN device utilizing a channel comprising a plurality of sub-channels. The phase rotating method comprises not using at least one sub-channel of the plurality of sub-channels according to a channel mask; generating a plurality of data sequences corresponding to the plurality of sub-channels excluding the at least one sub-channel; and performing phase rotations on the plurality of data sequences according to a plurality of angles corresponding to the plurality of sub-channels excluding the at least one sub-channel; wherein the channel is a contiguous channel.

The present invention further discloses a WLAN device, for executing the above-mentioned phase rotating method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an IEEE 802.11n standard packet structure according to the prior art.

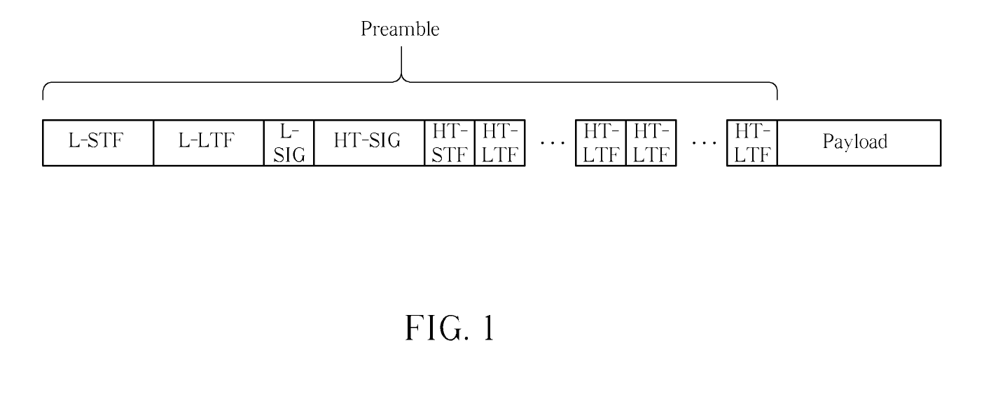

FIG. 2 is a schematic diagram of a wireless local area network (WLAN) device according to an embodiment of the present invention.

FIG. 3A to FIG. 3D are schematic diagrams of channel configurations of the WLAN device in FIG. 2.

FIG. 4A is a schematic diagram of a rotation table for the WLAN device in FIG. 2.

FIG. 4B is a schematic diagram of a common rotation table according to an embodiment of the present invention.

FIG. 5A is a schematic diagram of a wireless local area network (WLAN) device according to an embodiment of the present invention.

FIG. 5B is a schematic diagram of operations of a channel mask of the WLAN device in FIG. 5A.

FIG. 6 is a schematic diagram of a rotation table for the WLAN device in FIG. 5A.

FIG. 7 is a schematic diagram of a phase rotation process according to an embodiment of the present invention.

FIG. 8 is a schematic diagram of a phase rotation process according to another embodiment of the present invention.

### DETAILED DESCRIPTION

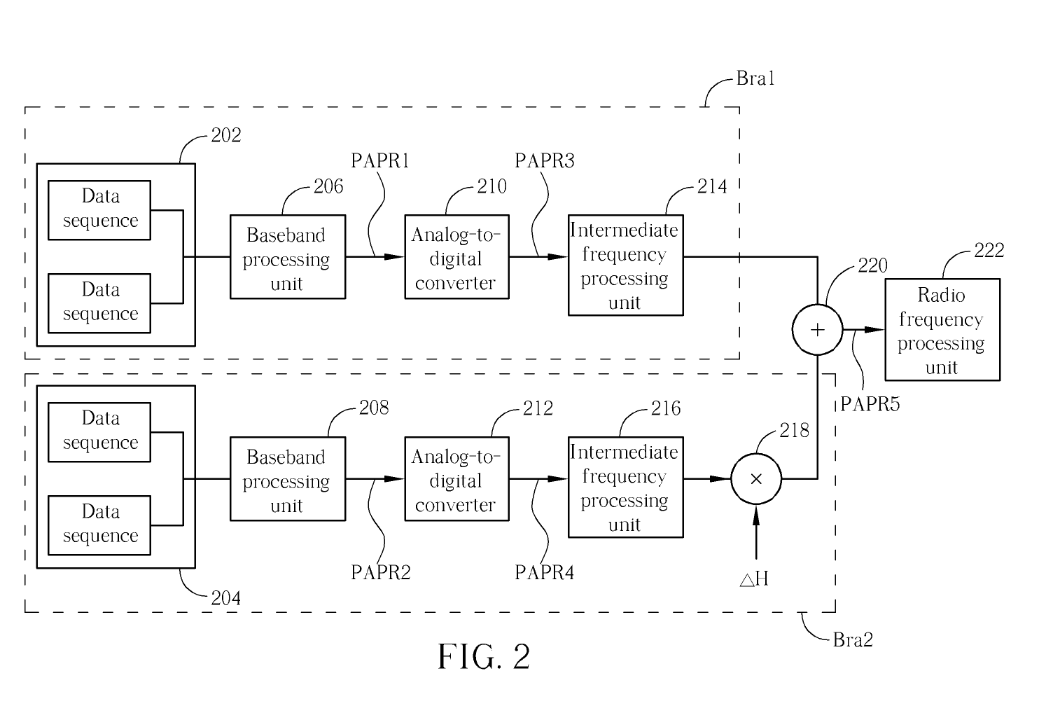

Please refer to FIG. 2, which is a schematic diagram of a wireless local area network (WLAN) device 20 according to an embodiment of the present invention. The WLAN device 20 comprises data sequence generation units 202, 204; baseband processing units 206, 208; analog-to-digital converters 210, 212; intermediate frequency (IF) processing units 214, 216; a mixer 218; an adder 220; and a radio frequency processing unit 222. Simply put, the WLAN device 20 conforms to IEEE 802.11ac standards, and includes two baseband/intermediate frequency (IF) branches Bra1, Bra2; the data sequence generation units 202, 204 generate data sequences for each sub-channel to the baseband processing units 206, 208, respectively; and the mixer 218 mixes a predefined frequency ΔHz to the branch Bra2, to separate the branches Bra1, Bra2 by a frequency interval of the predefined frequency ΔHz, i.e. to employ a non-contiguous transmission. Moreover, bandwidths of both the branches Bra1, Bra2 do not exceed 40 MHz, in other words, the bandwidths of the branches Bra1, Bra2 may be contiguous 20 MHz or contiguous 40 MHz.

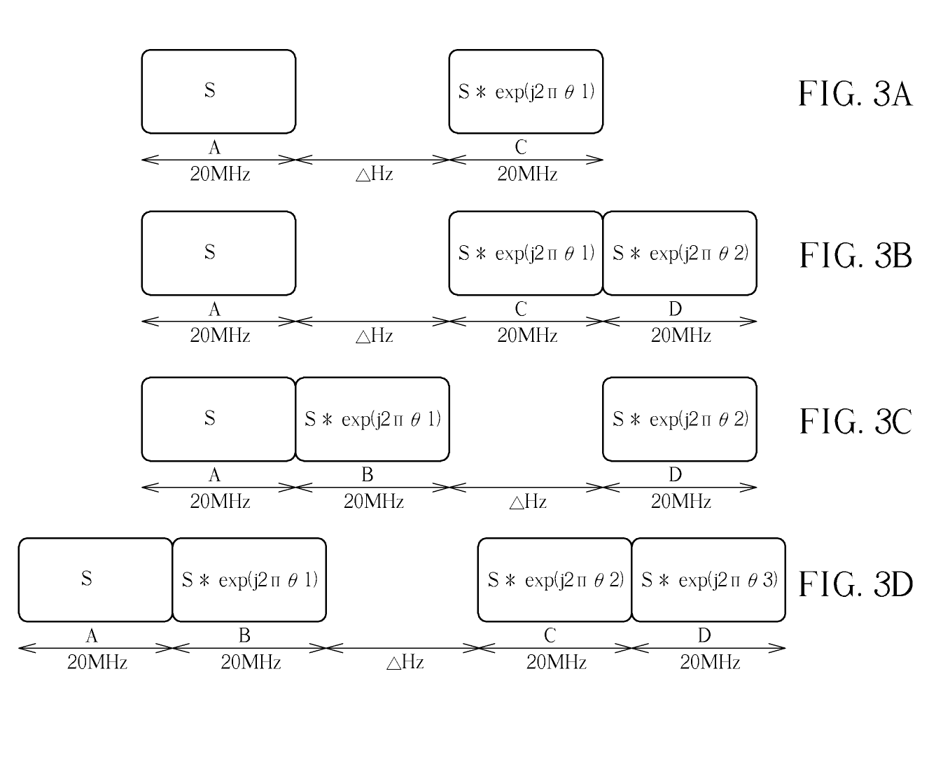

For instance, please refer to figures FIG. 3A to FIG. 3D, which are schematic diagrams of channel configurations of the WLAN device 20 in FIG. 2. As shown in FIG. 3A to FIG. 3D, the channel configuration of the WLAN device 20 can be divided into four cases as follows:

(1) 20+20: As shown in FIG. 3A, each of the branches Bra1, Bra2 is assigned by a 20 MHz sub-channel; a total system bandwidth of the WLAN device 20 is 40 MHz.
(2) 20+40: As shown in FIG. 3B, assigning a 20 MHz and a 40 MHz sub-channel to the branches Bra1, Bra2, respectively; a total system bandwidth of the WLAN device 20 is 60 MHz.
(3) 40+20: As shown in FIG. 3C, assigning a 40 MHz and a 20 MHz sub-channel to the branches Bra1, Bra2, respectively; a total system bandwidth of the WLAN device 20 is 60 MHz.
(4) 40+40: As shown in FIG. 3D, assigning a 40 MHz sub-channel to each of the branches Bra1, Bra2; a total system bandwidth of the WLAN device 20 is 80 MHz.

To evaluate peak-to-average power ratios PAPR1-PAPR5 for above-mentioned four channel configurations of the WLAN device 20, the present invention simulates transmission of a short training field (STF), wherein STF is modified from a 20 MHz legacy signal field (L-SIG) according to IEEE 802.11a standard. The 20 MHz L-SIG are repeated with different phase rotations θ1, θ2 and θ3, then transmitted via sub-channels corresponding to the above-mentioned four channel configurations. In the present invention, to reduce implementation complexity, each value of the phase rotation angles θ1, θ2, θ3 can only be selected from 0, 0.25, 0.5 or 0.75, i.e. the angles θ1, θ2, θ3 can only be 0°, 90°, 180° or 270°. Next, the above-mentioned four channel configurations are simulated with different phase rotation combinations, to obtain the peak-to-average power ratios PAPR1-PAPR5 in FIG. 2; the maximum values of the peak-to-average power ratios PAPR1-PAPR5 are recorded in each of the four channel configurations, to obtain an optimal phase rotation combination with optimized peak-to-average power ratios PAPR1-PAPR5.

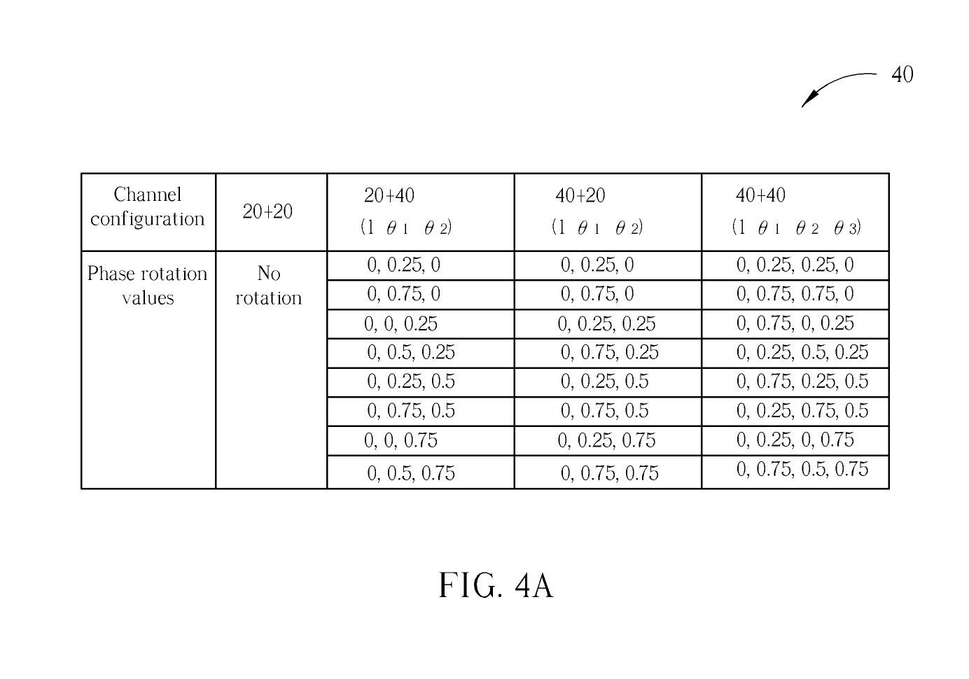

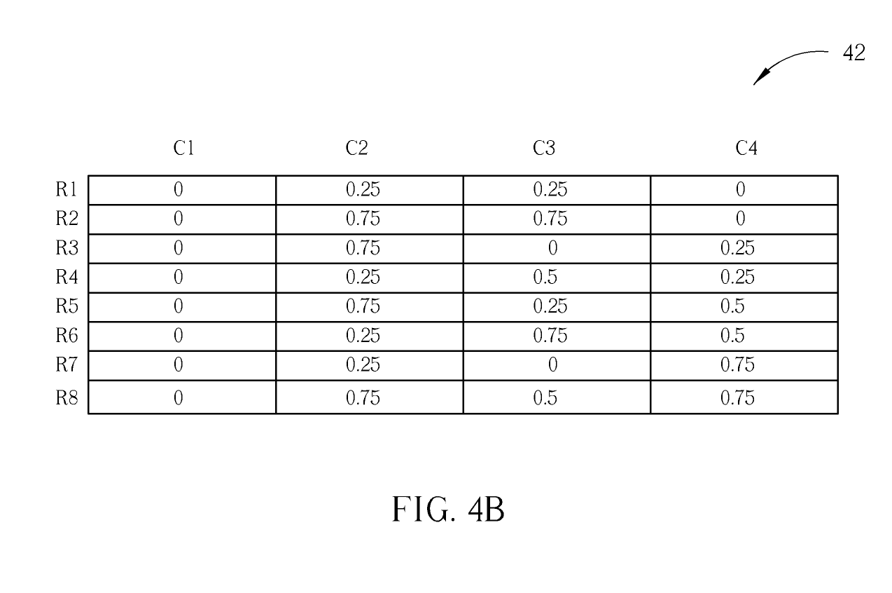

Please refer to FIG. 4A, which is a schematic diagram of a rotation table 40 for the WLAN device 20. As shown in FIG. 4A, the rotation table 40 indicates eight optimal phase rotation combinations for the angles θ1, θ2, θ3 under the above-mentioned four configurations (i.e. with minimum values of the peak-to-average power ratios PAPR1-PAPR5); wherein under the four channel configurations, all rotation angles for sub-channels with a lowest frequency band are 0, as phase rotation is not performed on these sub-channels. It should be noted that the 20+20 channel configuration in FIG. 3A can have optimal peak-to-average power ratios PAPR1-PAPR5 without phase rotations. It follows that, all of the eight phase rotation combinations under the four channel configurations render considerably low peak-to-average power ratios PAPR1-PAPR5, thus any phase rotation combination can be applied for data transmission in each sub-channel to reduce peak-to-average power ratios PAPR1-PAPR5.

Specifically, in the example of the 40+40 channel configuration in FIG. 3D, the WLAN device 20 has a total channel bandwidth of 80 MHz, with sub-channels A, B, C, D in ascending order of frequency bands, each sub-channel having a bandwidth of 20 MHz; wherein sub-channels B, C have an interval of a predefined frequency ΔHz. Phase rotation is not performed on a data sequence S in the sub-channel A, and data sequences in the sub-channels B, C, D undergo phase rotations with angles θ1, θ2, θ3, respectively, resulting in data sequences S*exp (j2πθ1), S*exp(j2πθ2), S*exp(j2πθ3), wherein the angles θ1, θ2, θ3 can be each chosen from any one of the eight optimal phase rotation combinations corresponding to the 40+40 channel configuration in FIG. 4A, to reduce the peak-to-average power ratios PAPR1-PAPR5. For example, choosing the first phase rotation combination 0, 0.25, 0.25; 0 denotes that the data sequence S of sub-channel A does not undergo phase rotation, and the data sequences S*exp(j2πθ1), S*exp(j2πθ2), S*exp(j2πθ3) of sub-channels B, C, D undergo phase rotations with angles 90°, 90°, 0°, respectively, to reduce peak-to-average power ratios PAPR1-PAPR5. Similar discussions can be applied for phase rotations for the 20+40 channel configuration in FIG. 3B and the 40+20 channel configuration in FIG. 3C.

More specifically, please refer to FIG. 4B, which is a schematic diagram of a common rotation table 42 according to an embodiment of the present invention. The common rotation table 42 is derived from the eight phase rotation combinations corresponding to the 40+40 channel configuration in FIG. 4A. Under a specific channel configuration, a phase rotation angle value for each channel is determined by a corresponding column in the common rotation table 42:

(1) 20+20: No phase rotation performed.
(2) 20+40: Use the columns C1, C3, C4 in the common rotation table 42.
(3) 40+20: Use the columns C1, C2, C4 in the common rotation table 42.
(4) 40+40: Use the columns C1, C2, C3, C4 in the common rotation table 42.

In the example of the 40+20 channel configuration in FIG. 3C, the phase rotation angles for each channel is obtained from the columns C1, C2, C4, i.e. the data sequence S of the sub-channel A does not undergo phase rotation as indicated by the column C1, and the data sequences S*exp(j2πθ1), S*exp(j2πθ2) of the sub-channels B, C undergo phase rotations with angle values corresponding to the columns C2, C4 in the eight phase rotation combinations, to reduce peak-to-average power ratios PAPR1-PAPR5. It is worth noting that, the common rotation table 42 is mainly derived from the eight phase rotation combinations corresponding to the 40+40 channel configuration in FIG. 4A, therefore though the columns C2, C4 for phase rotation under the 40+20 channel configuration in FIG. 4B and the eight phase rotation combinations in FIG. 4A are not listed in exactly same order (the third group interchanged with the fourth, and the fifth with the sixth), all of the eight phase rotation combinations render considerably low peak-to-average power ratios PAPR1-PAPR5, therefore any phase rotation combination can be utilized to reduce the peak-to-average power ratios PAPR1-PAPR5, irrelevant to the ordering of the eight phase rotation combinations. The usage of the common rotation table 42 for the 20+40 channel configuration in FIG. 3B and the 40+40 channel configuration in FIG. 3D may be similarly deduced.

Thus, the WLAN device 20 may store the common rotation table 42 in a memory, for the data sequence generation units 202, 204 to choose from any of the eight phase rotation combinations according to the channel configuration to perform phase rotations on the data sequence of each sub-channel when generating the data sequence of each sub-channel (the 20+20 channel configuration does not require phase rotation) to reduce peak-to-average power ratios PAPR1-PAPR5.

It should be noted that, the essence of the present invention is that the wireless local area network (WLAN) device may utilize a phase rotation combination, depending on the channel configuration, to perform phase rotation on the data sequence of each sub-channel, to reduce the peak-to-average power ratio during non-contiguous transmission. Those with ordinary skills in the art may make modifications or alterations accordingly, and are not limited thereto. For example, the channel bandwidth, number of sub-channels and sub-channel bandwidths of the WLAN device 20 is not limited to the aforementioned description; phase rotation combinations are not limited to those listed in the common rotation table 42, so long as peak-to-average power ratio is reduced; also, the above-mentioned rotation angles are chosen from 0, 0.25, 0.5, 0.75, i.e. 0°, 90°, 180° or 270°, when in practice they may be a combination of any other angle values; moreover, in the present invention, the data sequence undergoing phase rotations in each sub-channel is not limited to a specific data type (preamble data sequence), so long as the data sequence may undergo phase rotation to reduce peak-to-average power ratio; furthermore, the implementation of non-contiguous transmission in the present invention is not limited to the configuration of the WLAN device 20.

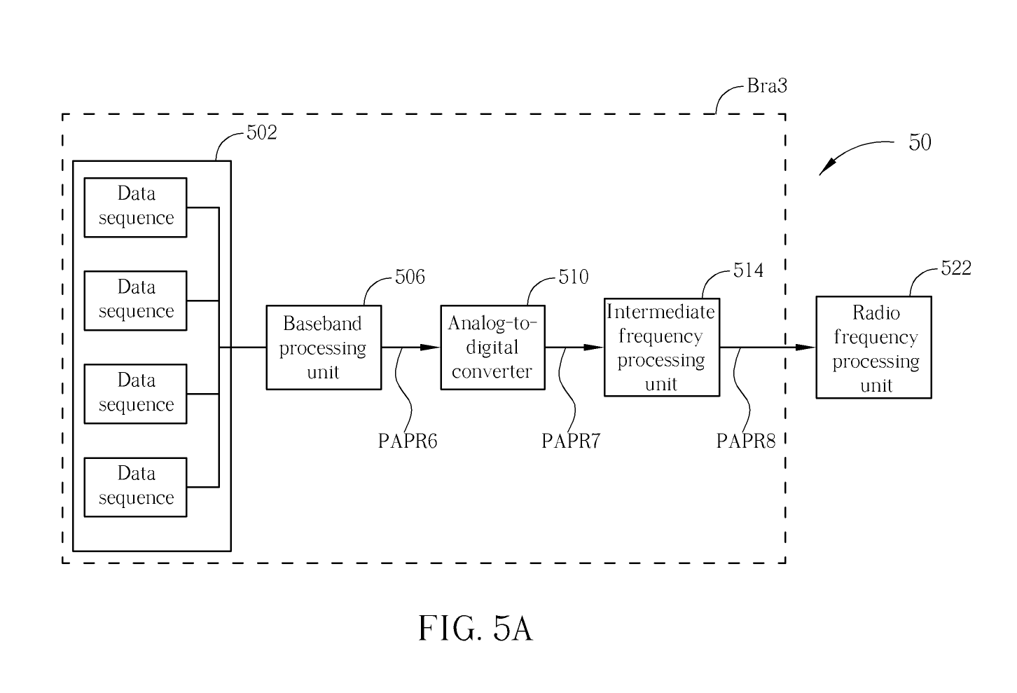

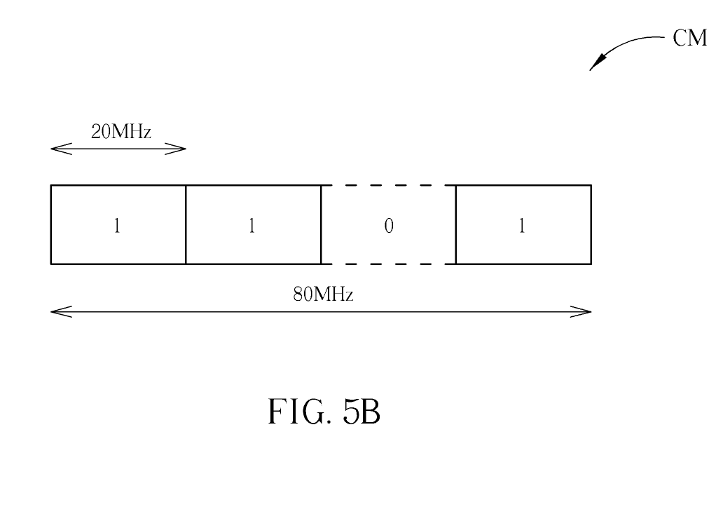

Please refer to FIG. 5A, which is a schematic diagram of a wireless local area network (WLAN) device 50 according to an embodiment of the present invention. The WLAN device 50 includes a data sequence generation unit 502, a baseband processing unit 506, an analog-to-digital converter 510, intermediate frequency (IF) processing units 514, 516 and a radio frequency processing unit 522. In short, the WLAN device 50 conforms to IEEE 802.11ac standards, and only includes one baseband/IF branch Bra3, i.e. to employ a contiguous channel for transmission; wherein the branch Bra3 has a bandwidth of 80 MHz, with each sub-channel having a bandwidth of 20 MHz. The data sequence generation unit 502 generates and sends data sequences for each sub-channel to the baseband processing unit 506.

It is worth noting that a main distinction between the WLAN device 50 and the WLAN device 20 is that the WLAN device 50 utilizes a channel mask to carry out non-contiguous transmission within a contiguous 80 MHz channel. Please refer to FIG. 5B, which is a schematic diagram of operations of a channel mask CM of the WLAN device 50 in FIG. 5A. As shown in FIG. 5B, the data sequence generation unit 502 utilizes predefined sub-channels for transmission as indicated by the channel mask CM. Due to the inactive sub-channel still having a bandwidth of 20 MHz, the sub-channels in use have a predefined bandwidth interval (in effect similar to the predefined frequency ΔHz in the WLAN device 20), thus equivalent to using non-contiguous transmission; wherein “1” denotes a 20 MHz sub-channel in use, and “0” denotes an inactive 20 MHz sub-channel.

Specifically, the baseband processing unit 506 can perform an inverse discrete Fourier transform to implement OFDM modulation, to transform a frequency domain input data sequence into a time domain OFDM symbol data sequence. Thus, the data sequence generation unit 502 can set zero as a default value for the data sequences of the sub-channels not in use, as indicated by the channel mask CM. In this way, when the WLAN device 50 is in process of transmission, the sub-channels indicated to be not in use by the channel mask CM would have no data, allowing the WLAN device 50 to execute non-contiguous transmission within a contiguous 80 MHz channel.

Therefore, following the above-mentioned method for evaluating the peak-to-average power ratios PAPR1-PAPR5 in the WLAN device 20, phase rotation combinations can be obtained for data sequences of each sub-channel in the WLAN device 50 under each channel mask CM, to reduce peak-to-average power ratios PAPR6-PAPR8.

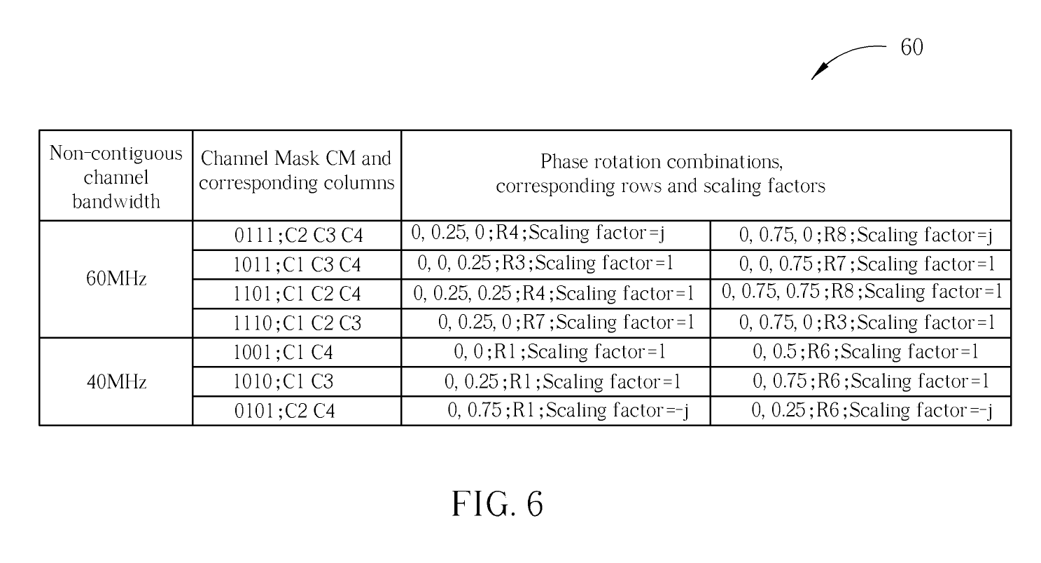

Please refer to FIG. 6, which is a schematic diagram of a rotation table 60 for the WLAN device 50. Despite differences in implementation for non-contiguous transmission between the WLAN device 50 and the WLAN device 20, both are non-contiguous transmissions, thus the rotation table 60, in addition to listing out two optimal phase rotation combinations for the data sequences of each sub-channel under each channel mask CM, also indicates a column index, row index and scaling factor corresponding to the common rotation table 42 for each phase rotation combination; wherein scaling factors 1, −1, +j or −j represent adding 0, 0.5, 0.25, 0.75 to the angle values in the common rotation table 42 and taking the decimal part (1's and 0's do not cause changes in phase); i.e. the angle values of the phase rotation combinations in rotation table 60; moreover, for each channel mask CM, phase rotation is not performed on sub-channels with lowest frequency bands.

In the example of a channel mask CM 0, 1, 0, 1, corresponding to the third group for 40 MHz non-contiguous channels in the rotation table 60, the optimal phase rotation combination is obtained from the columns C2, C4 in the common rotation table 42, with the two optimal phase rotation combinations 0, 0.75 and 0, 0.25; wherein the phase rotation combination 0, 0.75 corresponds to scaling row R1 of the common rotation table 42 by a scaling factor −j, i.e. (0.25, 0)+0.75=(0, 0.75); and the phase rotation combination 0, 0.25 corresponds to scaling row R6 by the scaling factor −j, i.e. (0.25, 0.5)+0.75=(0, 0.25). Usage for the rotation table 60 under other cases of channel masks CM may be similarly deduced.

As can be seen from the above, the present invention is not limited to configuration of the WLAN device 20, alternatively other configurations as in the WLAN device 50 may be employed for non-contiguous transmission, so long as a phase rotation combination can be utilized to perform phase rotation on the data sequence of each sub-channel depending on the channel configuration, to reduce peak-to-average power ratios during non-contiguous transmission; the aforementioned all fall within the scope of the present invention.

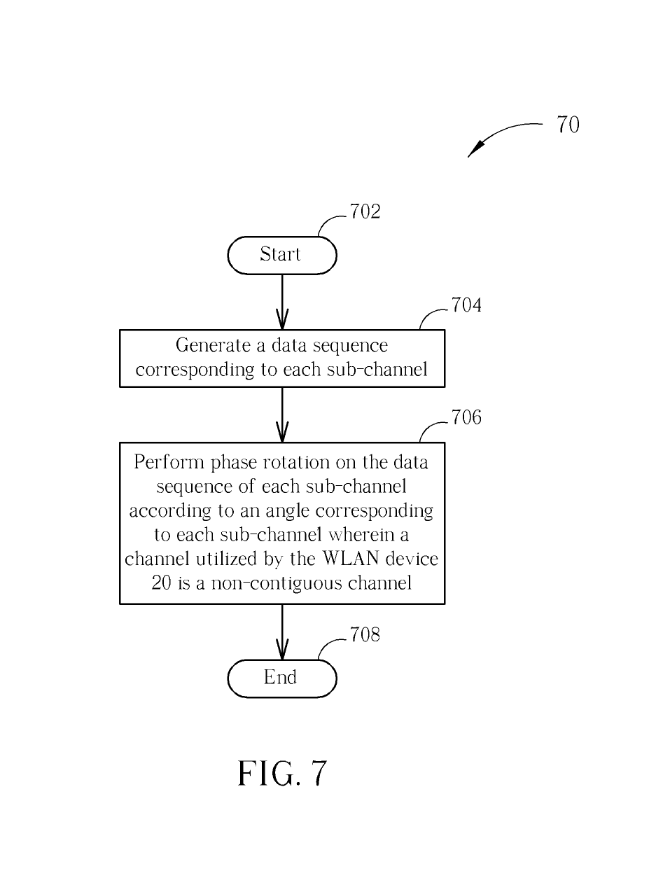

Operations of the WLAN device 20 may be summarized into a phase rotation process 70, as shown in FIG. 7, including the following steps:

Step 702: Start.

Step 704: Generate a data sequence corresponding to each sub-channel.

Step 706: Perform phase rotation on the data sequence of each sub-channel according to an angle corresponding to each sub-channel; wherein a channel utilized by the WLAN device 20 is a non-contiguous channel.

Step 708: End.

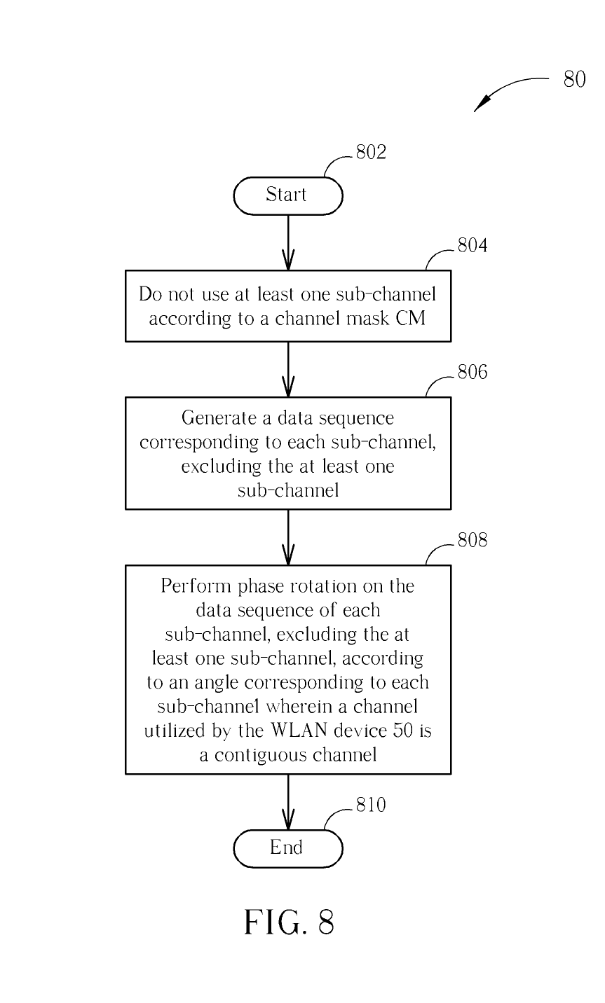

Operation of the WLAN device 50 may be summarized into a phase rotation process 80, as shown in FIG. 8, including the following steps:

Step 802: Start.

Step 804: Do not use at least one sub-channel according to a channel mask CM.

Step 806: Generate a data sequence corresponding to each sub-channel, excluding the at least one sub-channel.

Step 808: Perform phase rotation on the data sequence of each sub-channel, excluding the at least one sub-channel, according to an angle corresponding to each sub-channel; wherein a channel utilized by the WLAN device 50 is a contiguous channel.

Step 810: End.

For conciseness, please refer to the aforementioned discussion for phase rotation processes 70 and 80.

Phase rotation methods for 40 MHz channels according to the prior art can not be directly applied to non-contiguous channels with wider channel bandwidths to lower peak-to-average power ratio for preamble data transmission. Comparatively, for the WLAN device 20 using non-contiguous transmission, and for the WLAN device 50 using a channel mask to execute non-contiguous transmission within a contiguous channel, the present invention conducts transmission simulations and obtains the rotation tables 40, 60 and the common rotation table 42, for performing phase rotation on the data sequence of each sub-channel with a phase rotation combination depending on the channel configuration, to reduce peak-to-average power ratio during non-contiguous transmission.

In summary, when utilizing non-contiguous transmission, the present invention utilizes a combination of phase rotations depending on the channel configuration, to perform phase rotation on the data sequence of each sub-channel to lower peak-to-average power ratio.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A phase rotating method for a wireless local area network (WLAN) device, having a channel with a plurality of sub-channels, the phase rotating method comprising:
generating a plurality of data sequences corresponding to the plurality of sub-channels; and
performing phase rotations on the plurality of data sequences according to a plurality of angles corresponding to the plurality of sub-channels;
wherein the channel is a non-contiguous channel.

2. The phase rotating method of claim 1, wherein phase rotation is not performed on a data sequence corresponding to a sub-channel with a lowest frequency band of the plurality of sub-channels.

3. The phase rotating method of claim 1, wherein a bandwidth of the channel of the WLAN device is 40 MHz; and a bandwidth of each sub-channel of the plurality of sub-channels is 20 MHz.

4. The phase rotating method of claim 1, wherein the frequency bands of the plurality of sub-channels are in an ascending order of an interval of a predefined frequency.

5. The phase rotating method of claim 1, wherein the angles corresponding to the plurality of sub-channels are 0°.

6. The phase rotating method of claim 1, wherein a bandwidth of the channel of the WLAN device is 60 MHz; and a bandwidth of each sub-channel of the plurality of sub-channels is 20 MHz.

7. The phase rotating method of claim 1, wherein the plurality of sub-channels comprise a first sub-channel, a second sub-channel and a third sub-channel, wherein a first angle and a second angle of the plurality of angles corresponding to the second sub-channel and the third sub-channel are 90° and 0°, 270° and 0°, 0° and 90°, 180° and 90°, 90° and 180°, 270° and 180°, 0° and 270° or 180° and 270°, respectively.

8. The phase rotating method of claim 1, wherein the plurality of sub-channels comprise a first sub-channel, a second sub-channel and a third sub-channel, wherein a first angle and a second angle of the plurality of angles corresponding to the second sub-channel and the third sub-channel are 90° and 0°, 270° and 0°, 90° and 90°, 270° and 90°, 90° and 180°, 270° and 180°, 90° and 270° or 270° and 270°, respectively.

9. The phase rotating method of claim 1, wherein a bandwidth of the channel of the WLAN device is 80 MHz; and a bandwidth of each sub-channel of the plurality of sub-channels is 20 MHz.

10. The phase rotating method of claim 1, wherein the plurality of sub-channels comprise a first sub-channel, a second sub-channel, a third sub-channel and a fourth sub-channel, wherein a first angle, a second angle and a third angle of the plurality of angles corresponding to the second sub-channel, the third sub-channel and the fourth sub-channel are 90° and 90° and 0°, 270° and 270° and 0°, 270° and 0° and 90°, 90° and 180° and 90°, 270° and 90° and 180°, 90° and 270° and 180°, 90° and 0° and 270° or 270° and 180° and 270°, respectively.

11. A wireless local area network (WLAN) device, for executing the phase rotating method of claim 1.

12. A phase rotating method for a wireless local area network (WLAN) device, having a channel with a plurality of sub-channels, the phase rotating method comprising:
not using at least one sub-channel of the plurality of sub-channels according to a channel mask;
generating a plurality of data sequences corresponding to the plurality of sub-channels excluding the at least one sub-channel; and
performing phase rotations on the plurality of data sequences according to a plurality of angles corresponding to the plurality of sub-channels excluding the at least one sub-channel;
wherein the channel is a contiguous channel.

13. The phase rotating method of claim 12, wherein phase rotation is not performed on a sub-channel with a lowest frequency band of the plurality of sub-channels excluding the at least one sub-channel.

14. The phase rotating method of claim 12, wherein the step of not using the at least one sub-channel of the plurality of sub-channels according to the channel mask comprises setting values of data sequences of the at least one sub-channel zero when performing an inverse fast Fourier transform (IFFT).

15. The phase rotating method of claim 12, wherein a bandwidth of the channel of the wireless local area network (WLAN) device is 80 MHz; and a bandwidth of each sub-channel of the plurality of sub-channels is 20 MHz.

16. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the first sub-channel, wherein a first angle and a second angle of the plurality of angles corresponding to the third sub-channel and the fourth sub-channel are 90° and 0° or 270° and 0°, respectively.

17. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the second sub-channel, wherein a first angle and a second angle of the plurality of angles corresponding to the third sub-channel and the fourth sub-channel are 0° and 90° or 0° and 270°, respectively.

18. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the third sub-channel, wherein a first angle and a second angle of the plurality of angles corresponding to the second sub-channel and the fourth sub-channel are 90° and 90° or 270° and 270°, respectively.

19. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the fourth sub-channel, wherein a first angle and a second angle of the plurality of angles corresponding to the second sub-channel and the third sub-channel are 90° and 0° or 270° and 0°, respectively.

20. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the second sub-channel and the third sub-channel, wherein a first angle of the plurality of angles corresponding to the fourth sub-channel is 0° or 180°.

21. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the second sub-channel and the fourth sub-channel, wherein a first angle of the plurality of angles corresponding to the third sub-channel is 90° or 270°.

22. The phase rotating method of claim 15, wherein the plurality of sub-channels comprise a first sub-channel, a second sub-channel, a third sub-channel and a fourth sub-channel in ascending order of corresponding frequency bands, wherein the channel mask indicates not using the first sub-channel and the third sub-channel, wherein a first angle of the plurality of angles corresponding to the fourth sub-channel is 270° or 90°.

23. A wireless local area network (WLAN) device, for executing the phase rotating method of claim 12.
